(19) United States
(12) Patent Application Publication
(10) Pub. No.: US 2022/0296940 A1
(43) Pub. Date: Sep. 22, 2022

(54) Communications Enabled Respirator Assembly

(71) Applicants: Phillip Edwards, Vaughan (CA); Dalton Gilbert, Vaughan (CA); Karen Grey, Vaughan (CA)

(72) Inventors: Phillip Edwards, Vaughan (CA); Dalton Gilbert, Vaughan (CA); Karen Grey, Vaughan (CA)

(21) Appl. No.: 17/203,939

(22) Filed: Mar. 17, 2021

(51) Int. Cl. A62B 18/08; A62B 7/10; A62B 23/02; A62B 9/00; H04R 1/02

(52) U.S. Cl. CPC A62B 18/08; A62B 7/10; A62B 23/025; A62B 18/084; A62B 23/02; A62B 9/006; A62B 9/00; H04R 1/028

(57) ABSTRACT

A communications enabled respirator assembly for amplifying and transmitting vocalizations of a user includes a panel, which cup shaped, substantially rigid, and can filter particulates from air passing through the panel. A coupler engaged to the panel engages the panel to a head of a user. The panel is positioned over a nose and a mouth of the user, positioning the coupler to engage the head of the user to sealably engage the panel to a face of the user. The panel is positioned to filter particulates from air passing through the panel. A communications module engaged to the panel can perform one or more of amplifying and transmitting vocalizations of the user. The communications module thus enhances vocalizations of the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to respirator assemblies and more particularly pertains to a new respirator assembly for amplifying and transmitting vocalizations of a user. The present invention discloses is a respirator assembly comprising a detachable microphone and speaker, and which is configured for wireless transmission.

### (2) Description of Related Art Including Information Disclosed Under 37 CFR 1.97 and 1.98

The prior art relates to respirator assemblies. Prior art respirator assemblies may comprise masks having earphones, microphones, laser microphones, speakers, and the like. What is lacking in the prior art is a respirator assembly comprising a detachable microphone and speaker, and which is configured for wireless transmission.

### BRIEF SUMMARY OF THE INVENTION

An embodiment of the disclosure meets the needs presented above by generally comprising a panel, which cup shaped, substantially rigid, and configured to filter particulates from air passing through the panel. A coupler engaged to the panel is configured to engage the panel to a head of a user. The panel is configured to position over a nose and a mouth of the user, positioning the coupler to engage the head of the user to sealably engage the panel to a face of the user. The panel is positioned and configured to filter particulates from air passing through the panel. A communications module engaged to the panel is configured for one or more of amplifying and transmitting vocalizations of the user. The communications module thus is configured to enhance vocalizations of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a communications enabled respirator assembly according to an embodiment of the disclosure.

FIG. 2 is a rear view of an embodiment of the disclosure.

FIG. 3 is a side view of an embodiment of the disclosure.

FIG. 4 is an exploded view of an embodiment of the disclosure.

FIG. 5 is a detailed cross-sectional view of an embodiment of the disclosure.

### DETAILED DESCRIPTION OF THE INVENTION

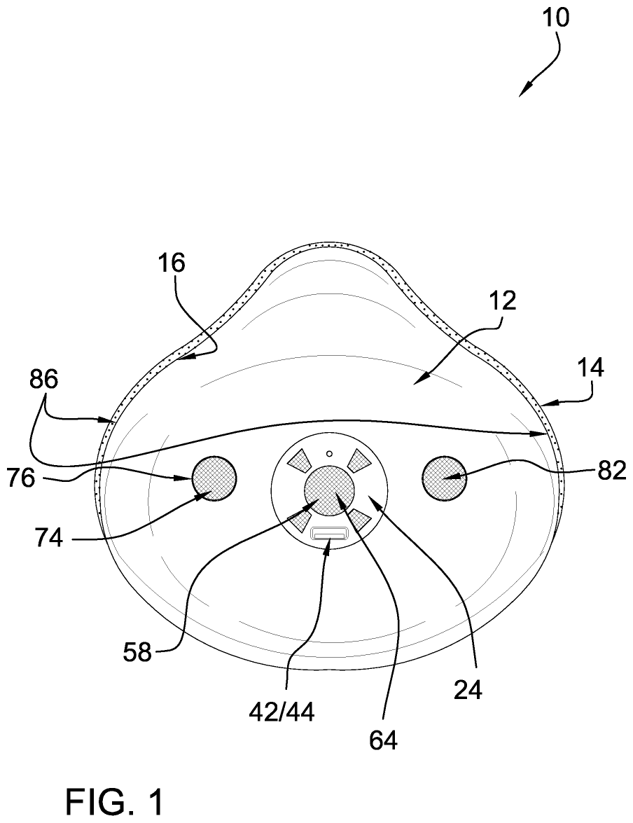

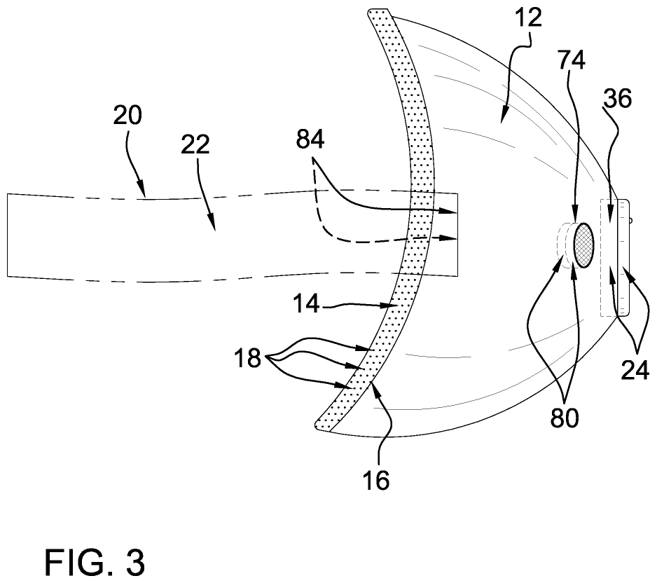

With reference now to the drawings, and in particular to FIGS. 1 through 5 thereof, a new respirator assembly embodying the principles and concepts of an embodiment of the disclosure and generally designated by the reference numeral 10 will be described.

As best illustrated in FIGS. 1 through 5, the communications enabled respirator assembly 10 generally comprises a panel 12, which is cup shaped, substantially rigid, and configured to filter particulates from air passing through the panel 12. The panel 12 comprises one or more of polypropylene, cellulose, polyester, polyurethane, and the like.

A lip 14 is engaged to a perimeter 16 of the panel 12. The lip 14 comprises one or more of rubber, silicone, elastomer, and the like, and thus is resiliently compressible and configured to conform to contours of a face of a user. A plurality of channels 18, which extends through the lip, is configured to allow escape of moisture from skin positioned under the lip 14.

A coupler 20 engaged to the panel 12 is configured to engage the panel 12 to a head of a user. The panel 12 is configured to position over a nose and a mouth of the user, positioning the coupler 20 to engage the head of the user to sealably engage the panel 12 to a face of the user. The panel 12 is positioned and configured to filter particulates from air passing through the panel 12. The present invention also anticipates the panel 12 comprising half-face elastomeric respirators, full-face elastomeric respirators, and the like.

The coupler 20 may comprise a strap 22, which has opposed ends 84 engaged singly to opposed edges 86 of the panel 12. The strap 22 comprises one or more of rubber, silicone, elastomer, and the like, and thus is resiliently stretchable. The strap 22 is configured to be stretched to position the strap 22 around the head of the user, with the panel 12 positioned over the nose and the mouth of the user. The strap 22 is configured to rebound so that the panel 12 is removably coupled to the head of the user and sealably positioned over the nose and the mouth of the user. The present invention also anticipates the coupler 20 comprising other coupling means, such as, but not limited to, pairs of ear loops, pairs of head loops, and the like.

A communications module 24 engaged to the panel 12 is configured for one or more of amplifying and transmitting vocalizations of the user. The communications module 24 thus is configured to enhance vocalizations of the user. The present invention is anticipated to overcome the impairment to user vocalization induced by prior art respirator assemblies. The impairment to user vocalization induced by use of prior art respirator assemblies leads to noncompliance and impaired communication.

The communications module 24 comprises a housing 26, which defines an internal space 28 and which is selectively engageable to the panel 12. The housing 26 is shaped complementarily to a cutout 30 positioned in the panel 12. The cutout 30 is positioned for selective insertion of the housing 26 to removably engage the housing 26 to the panel 12. The cutout 30 is substantially centrally positioned in the panel 12 so that the communications module 24 is positioned proximate to the mouth of the user when the panel 12 is positioned over the nose and the mouth of the user.

The housing 26 is disc shaped. A gasket 32 is engaged to a perimeter 34 of the housing 26. A ring 36 is engaged to a circumference 38 of the cutout 30. The gasket 32 is positioned to sealably engage the ring 36 as the housing 26 is inserted into the cutout 30.

A battery 40, which is rechargeable, is engaged to the housing 26 and positioned in the internal space 28. A charging port 42 engaged to the housing 26 is operationally engaged to the battery 40. The charging port 42 is configured to engage a plug of a charging cord (not shown) to engage the battery 40 to a source of electrical current to charge the battery 40. The charging port 42 may comprise a Universal Serial Bus port 44, as shown in FIG. 1.

A microprocessor 46 is engaged to the housing 26, positioned in the internal space 28, and operationally engaged to the battery 40. A switch 48, which is voice operated, is operationally engaged to the microprocessor 46. The switch 48 is configured to detect a vocalization by the user and to operationally engage the microprocessor 46 to the battery 40. As will become apparent, the switch 48 prolongs operation time of the communications module 24 by turning off the microprocessor 46 and components operationally coupled to the microprocessor 46 when the user is not vocalizing.

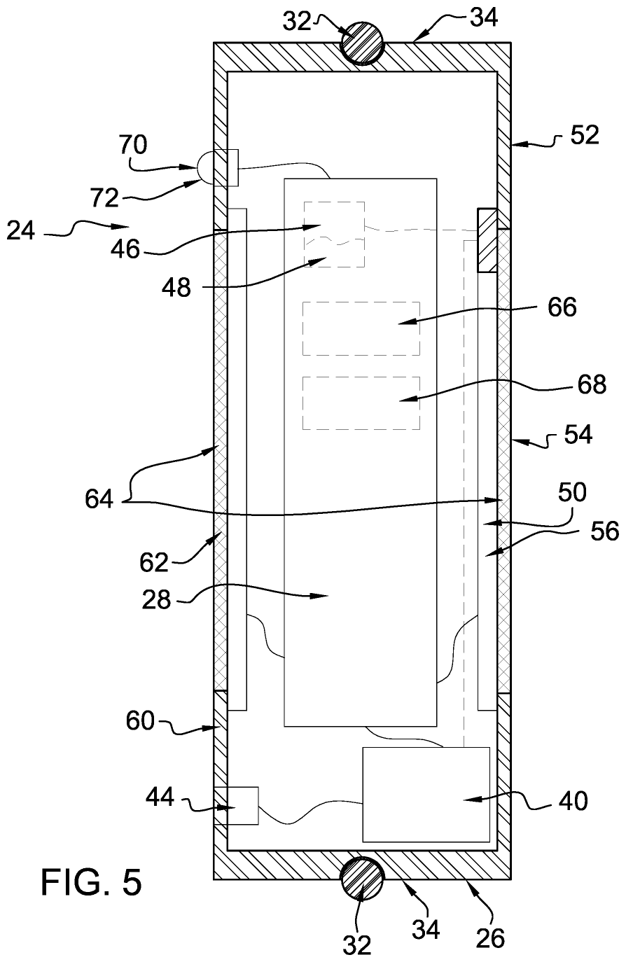

A microphone 50 is engaged to an inner wall 52 of the housing 26 and positioned in the internal space 28. The microphone 50 is positioned to close a first void 54 positioned in the inner wall 52. The microphone 50 is operationally engaged to the microprocessor 46. The microphone 50 may comprise a piezoelectric transducer 56, as shown in FIG. 5, or a microphone 50 relying on fiberoptics, microelectromechanical systems (MEMs), and the like.

A speaker 58 is engaged to an outer wall 60 of the housing 26 and positioned in the internal space 28. The speaker 58 is positioned to close a second void 62 positioned in the outer wall 60. The speaker 58 is operationally engaged to the microprocessor 46. Each of a pair of grates 64 is engaged to the housing 26 and covers a respective one of the first void 54 and the second void 62.

An amplifier 66 is engaged to the housing 26, positioned in the internal space 28, and operationally engaged to the microprocessor 46. Vocalizations of the user are picked up by the microphone 50, amplified by the amplifier 66, and broadcast by the speaker 58.

A transceiver 68 is engaged to the housing 26, positioned in the internal space 28, and operationally engaged to the microprocessor 46. The transceiver 68 is configured to transmit vocalizations of the user to an electronic device (not shown). For example, the transceiver 68 could be paired with a public address system, a phone, and the like. When the transceiver 68 is paired with a phone, the system 10 also could comprise an earbud (not shown), selectively positionable in an ear of the user and paired with the phone. The communications module 24 and the earbud would enable the user to conduct phone conversations.

A bulb 70 engaged to the outer wall 60 of the housing 26 is operationally engaged to the microprocessor 46. The microprocessor 46 is positioned to selectively actuate the bulb 70 to indicate an activity status of the communications module 24. The bulb 70 comprises a light emitting diode 72.

The assembly 10 also may comprise a filter module 74, which is selectively engageable to the panel 12 so that the filter module 74 occupies a hole 76 positioned in the panel 12. An adapter 78 is engaged to the panel 12 and positioned in the hole 76. The adapter 78 is configured to reversibly engage the filter module 74 to removably engage the filter module 74 to the panel 12. The filter module 74 is configured to ventilate a space between the panel 12 and the face of the user. Ventilating the space between the panel 12 and the face of the user helps to prevent fogging of glasses that may be worn by a user. The present invention also anticipates ventilating of the space between the panel 12 and the face of the user being accomplished using one or more one-way valves.

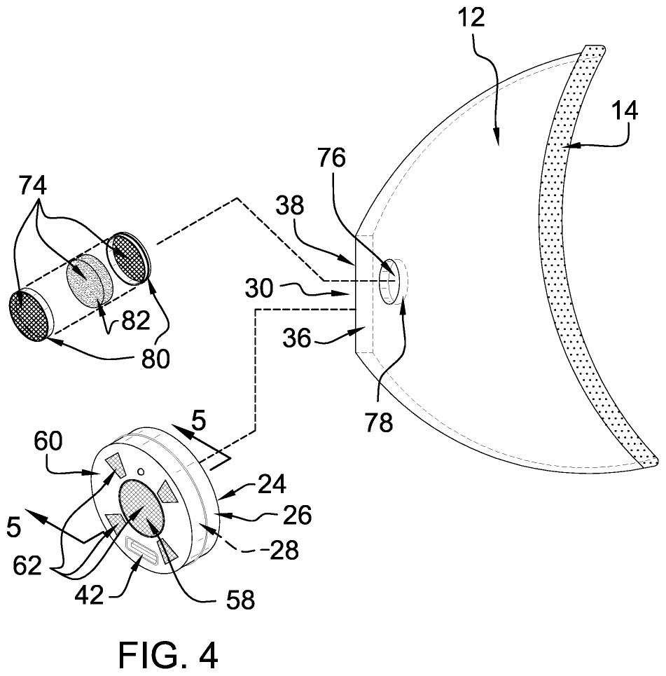

The filter module 74 may comprise a pair of discs 80 and a filter 82, as shown in FIG. 4. The discs 80 are meshed. The filter 82 is selectively couplable to the pair of discs 80 so that the filter 82 is sandwiched between the discs 80. The filter 82 being selectively couplable to the pair of discs 80 allows for its replacement.

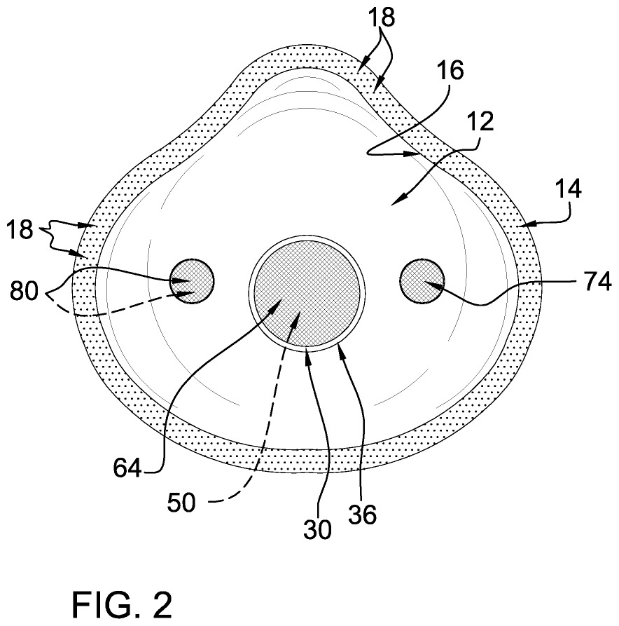

The filter module 74 may be one of a pair of filter modules 74, as shown in FIG. 1, with each filter module 74 being engageable to the panel 12 to occupy a respective one of a pair of holes 76 positioned in the panel 12. As shown in FIG. 2, the holes 76 of the pair of holes 76 bracket the communications module 24.

In one example of use, the strap 22 is stretched to position it around a head of the user with the panel 12 positioned over the nose and the mouth of the user. The strap 22 rebounds so that the panel 12 is removably coupled to the head of the user and sealably positioned over the nose and the mouth of the user. Vocalizations of the user then are picked up by the microphone 50, amplified by the amplifier 66, and broadcast by the speaker 58.

In another example of use, the transceiver 68 and an earbud can be paired with a phone so that the user can carry on a phone conversation.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A communications enabled respirator assembly comprising:
a panel, the panel being cup shaped, substantially rigid, and configured for filtering particulates from air passing through the panel;
a coupler engaged to the panel and being configured for engaging the panel to a head of a user, wherein the panel is configured for positioning over a nose and a mouth of the user, positioning the coupler for engaging the head of the user for sealably engaging the panel to a face of the user, wherein the panel is configured for filtering particulates from air passing through the panel; and
a communications module engaged to the panel and being configured for one or more of amplifying and transmitting vocalizations of the user, wherein the communications module is configured for enhancing vocalizations of the user.

2. The communications enabled respirator assembly of claim 1, wherein the panel comprises one or more of polypropylene, cellulose, polyester, and polyurethane.

3. The communications enabled respirator assembly of claim 1, further including a lip engaged to a perimeter of the panel, the lip being resiliently compressible, such that the lip is configured for conforming to contours of the face of the user.

4. The communications enabled respirator assembly of claim 3, wherein the lip comprises one or more of rubber, silicone, and elastomer.

5. The communications enabled respirator assembly of claim 3, further including a plurality of channels extending through the lip, wherein the channels are configured for escape of moisture from skin positioned under the lip.

6. The communications enabled respirator assembly of claim 1, wherein the coupler comprises a strap having opposed ends engaged singly to opposed edges of the panel, the strap being resiliently stretchable, wherein the strap is configured for stretching for positioning the strap around a head of the user with the panel positioned over the nose and the mouth of the user, wherein the strap is configured for rebounding such that the panel is removably coupled to the head of the user and sealably positioned over the nose and the mouth of the user.

7. The communications enabled respirator assembly of claim 6, wherein the strap comprises one or more of rubber, silicone, and elastomer.

8. The communications enabled respirator assembly of claim 1, wherein the communications module comprises:
a housing defining an internal space and being selectively engageable to the panel;
a battery engaged to the housing and positioned in the internal space, the battery being rechargeable;
a charging port engaged to the housing and operationally engaged to the battery, wherein the charging port is configured for engaging a plug of a charging cord for engaging the battery to a source of electrical current for charging the battery;
a microprocessor engaged to the housing and positioned in the internal space, the microprocessor being operationally engaged to the battery;
a microphone engaged to an inner wall of the housing and positioned in the internal space, the microphone being positioned to close a first void positioned in the inner wall, the microphone being operationally engaged to the microprocessor;
a speaker engaged to an outer wall of the housing and positioned in the internal space, the speaker being positioned to close a second void positioned in the outer wall, the speaker being operationally engaged to the microprocessor; and
an amplifier engaged to the housing and positioned in the internal space, the amplifier being operationally engaged to the microprocessor.

9. The communications enabled respirator assembly of claim 8, wherein:
the housing is shaped complementarily to a cutout positioned in the panel, such that the cutout is positioned for selective insertion of the housing for removably engaging the housing to the panel, the housing is disc shaped; and
the cutout is substantially centrally positioned in the panel, such that the communications module is positioned proximate to the mouth of the user when the panel is positioned over the nose and the mouth of the user.

10. The communications enabled respirator assembly of claim 9, further including:
a gasket engaged to a perimeter of the housing; and
a ring engaged to a circumference of the cutout, such that the gasket is positioned for sealably engaging the ring as the housing is inserted into the cutout.

11. The communications enabled respirator assembly of claim 8, wherein the microphone comprises a piezoelectric transducer.

12. The communications enabled respirator assembly of claim 8, further including a pair of grates, each grate being engaged to the housing and covering a respective one of the first void and the second void.

13. The communications enabled respirator assembly of claim 8, further including a switch, the switch being voice operated and operationally engaged to the microprocessor, wherein the switch is configured for detecting a vocalization by the user and operationally engaging the microprocessor to the battery.

14. The communications enabled respirator assembly of claim 8, further including a transceiver engaged to the housing and positioned in the internal space, the transceiver being operationally engaged to the microprocessor, wherein the transceiver is configured for transmitting vocalizations of the user to an electronic device.

15. The communications enabled respirator assembly of claim 8, further including a bulb engaged to the outer wall of the housing, the bulb being operationally engaged to the microprocessor, such that the microprocessor is positioned for selectively actuating the bulb for indicating an activity status of the communications module, the bulb comprising a light emitting diode.

16. The communications enabled respirator assembly of claim 1, further including:
a hole positioned in the panel; and
a filter module selectively engageable to the panel, such that the filter module occupies the hole, wherein the filter module is configured for venting a space between the panel and the face of the user.

17. The communications enabled respirator assembly of claim 16, wherein the filter module comprises a pair of discs and a filter, the discs being meshed, the filter being selectively couplable to the pair of discs, such that the filter is sandwiched between the discs.

18. The communications enabled respirator assembly of claim 16, wherein the filter module is one of a pair of filter modules, each filter module being engageable to the panel to occupy a respective one of a pair of holes positioned in the panel, the holes of the pair of holes bracketing the communications module.

19. The communications enabled respirator assembly of claim 16, further including an adapter engaged to the panel and positioned in the hole, the adapter being configured for reversibly engaging the filter module for removably engaging the filter module to the panel.

20. A communications enabled respirator assembly comprising:
a panel, the panel being cup shaped, substantially rigid, and configured for filtering particulates from air passing through the panel, the panel comprising one or more of polypropylene, cellulose, polyester, and polyurethane;
a lip engaged to a perimeter of the panel, the lip being resiliently compressible, such that the lip is configured for conforming to contours of a face of a user, the lip comprising one or more of rubber, silicone, and elastomer;
a plurality of channels extending through the lip, wherein the channels are configured for escape of moisture from skin positioned under the lip;
a coupler engaged to the panel and being configured for engaging the panel to a head of the user, wherein the panel is configured for positioning over a nose and a mouth of the user, positioning the coupler for engaging the head of the user for sealably engaging the panel to the face of the user, wherein the panel is configured for filtering particulates from air passing through the panel, the coupler comprising a strap having opposed ends engaged singly to opposed edges of the panel, the strap being resiliently stretchable, wherein the strap is configured for stretching for positioning the strap around a head of the user with the panel positioned over the nose and the mouth of the user, wherein the strap is configured for rebounding such that the panel is removably coupled to the head of the user and sealably positioned over the nose and the mouth of the user, the strap comprising one or more of rubber, silicone, and elastomer;
a communications module engaged to the panel and being configured for one or more of amplifying and transmitting vocalizations of the user, wherein the communications module is configured for enhancing vocalizations of the user, the communications module comprising:
a housing defining an internal space and being selectively engageable to the panel, the housing being shaped complementarily to a cutout positioned in the panel, such that the cutout is positioned for selective insertion of the housing for removably engaging the housing to the panel, the housing being disc shaped, the cutout being substantially centrally positioned in the panel, such that the communications module is positioned proximate to the mouth of the user when the panel is positioned over the nose and the mouth of the user,
a gasket engaged to a perimeter of the housing,
a ring engaged to a circumference of the cutout, such that the gasket is positioned for sealably engaging the ring as the housing is inserted into the cutout,
a battery engaged to the housing and positioned in the internal space, the battery being rechargeable,
a charging port engaged to the housing and operationally engaged to the battery, wherein the charging port is configured for engaging a plug of a charging cord for engaging the battery to a source of electrical current for charging the battery,
a microprocessor engaged to the housing and positioned in the internal space, the microprocessor being operationally engaged to the battery,
a microphone engaged to an inner wall of the housing and positioned in the internal space, the microphone being positioned to close a first void positioned in the inner wall, the microphone being operationally engaged to the microprocessor, the microphone comprising a piezoelectric transducer,
a speaker engaged to an outer wall of the housing and positioned in the internal space, the speaker being positioned to close a second void positioned in the outer wall, the speaker being operationally engaged to the microprocessor,
a pair of grates, each grate being engaged to the housing and covering a respective one of the first void and the second void,
an amplifier engaged to the housing and positioned in the internal space, the amplifier being operationally engaged to the microprocessor,
a switch, the switch being voice operated and operationally engaged to the microprocessor, wherein the switch is configured for detecting a vocalization by the user and operationally engaging the microprocessor to the battery,
a transceiver engaged to the housing and positioned in the internal space, the transceiver being operationally engaged to the microprocessor, wherein the transceiver is configured for transmitting vocalizations of the user to an electronic device, and
a bulb engaged to the outer wall of the housing, the bulb being operationally engaged to the microprocessor, such that the microprocessor is positioned for selectively actuating the bulb for indicating an activity status of the communications module, the bulb comprising a light emitting diode;
a hole positioned in the panel;
a filter module selectively engageable to the panel, such that the filter module occupies the hole, wherein the filter module is configured for venting a space between the panel and the face of the user, the filter module comprising a pair of discs and a filter, the discs being meshed, the filter being selectively couplable to the pair of discs, such that the filter is sandwiched between the discs, the filter module being one of a pair of filter modules, each filter module being engageable to the panel to occupy a respective one of a pair of holes positioned in the panel, the holes of the pair of holes bracketing the communications module; and
an adapter engaged to the panel and positioned in the hole, the adapter being configured for reversibly engaging the filter module for removably engaging the filter module to the panel.
